(19) United States
(12) Patent Application Publication
(10) Pub. No.: US 2002/0092919 A1
(43) Pub. Date: Jul. 18, 2002

(54) Filtered drinking straw

(76) Inventor: Jason Patrick Campagna, Chalmette, LA (US)

Correspondence Address: Jason Patrick Campagna, 2007 Corinne Dr., Chalmette, LA, 70043, US

(21) Appl. No.: 10/043,045

(22) Filed: Jan. 9, 2002

Related U.S. Application Data
(60) Provisional application No. 60/261,249, filed on Jan. 16, 2001.

(51) Int. Cl. A61J 15/00

(52) U.S. Cl. 239/33

(57) ABSTRACT

A filtered drinking straw for filtering liquids passing through the drinking straw tube. The filtered drinking straw is an elongated upright tube possessing a pair of positioned aperture ends with a filtering apparatus that prevents objects of a predetermined size from entering the tube. This filtering apparatus is in the liquid path and is affixed either at one aperture end or runs the predetermined length of the tube. This filtering apparatus allows liquids to pass but not the undesirable objects of a predetermined size from entering the tube and subsequently being stuck in the tube and or being possibly consumed.

### FEDERALLY SPONSERED RESEARCH

Not Applicable

### SEQUENCE LISTING OR PROGRAM

Not Applicable

### BACKGROUND

1. Field of Invention

This invention relates to drinking straws and more particularly pertains to a new filtered drinking straw, which allows liquid to pass unabated, while blocking undesirable objects found in some citrus flavored liquids.

2. Descripition of Prior Art

Historically, citrus flavoring has been a way to add additional tastes to a variety of beverages. Today, the taste of iced tea, sodas, lemonade, fruit drinks, and water, is enhanced by the use of sliced citrus. Beverages are indispensable in restaurants and homes. The use of sliced citrus as flavoring is popular and is ever growing, reaching ever corner of the world. However, there has been a much overlooked and under investigated aspect of flavoring beverages.

Today the drinking straw is a modern marvel. Invented in the late 1890's, the drinking straw has been utilized for over 100 years. There have been many advances in drinking straw design, structure, and materials utilized, however, one aspect has still been overlooked.

For many consumers slices of lemons, oranges, and other citrus have been utilized to flavor beverages. There have been attempts to wrap the sliced citrus in mesh bags to restrict the flow of pulp and seeds the sliced citrus contains. These attempts have been moderately successful. However, this practice has been utilized less and less. This is predominately due to the increase in service consumers want and the increase expense in time, labor, and supplies necessary to prepare such a package for use.

There has been the widely accepted use of flavor concentrates. Any person who has used these flavor concentrates can say that it is a poor substitute for a real slice of citrus flavoring their beverage. However, this widely accepted use for flavor concentrates has occurred in more homes than in restaurants. When one patronizes a restaurant, they want the freshest condiments and the most tasteful food available. That is one of the benefits of dinning out. Flavor concentrates do nothing for freshness nor taste consumers expect. Furthermore, there is nothing appealing about flavor concentrates and their sometimes chemical, artificial taste. Nothing beats a fresh lemon or an orange.

The problem, how to minimize the common nuisance of citrus seeds being taken up into a drinking straw, possibly getting stuck within the tube, becoming a foreign object in the mouth or more so being consumed by the individual.

The use of filtering devices is known in the prior art. However, a majority of the prior art lends itself for use with medication and drug administration. More specifically, the filtering devices used are to suspend medication on the inside of the drinking straw for patient consumption. Furthermore, the filtering devices keep medication on the inside of the straw instead of keeping certain objects from entering the straw. While these drinking straws are designed for the sole purpose of the administration of medicine, they certainly would not be a good choice to filter out citrus seeds from liquids. U.S. Pat. No. 5,718,681 by Maiming; U.S. Pat. No. 6,217,545 by Haldopoulos; U.S. Pat. No. D271,836 by Border.

The use of filtering devices is known in the prior art. However, the referenced prior art deals with a combination of items including a straw, stirrer and citrus squeezer. U.S. Pat. No. 6,056,206 by Whiton.

The use of filtering devices is known in the prior art However, the referenced prior art deals with a flavoring delivery drinking straw. This device utilizes filters in a way that suspends a flavoring unit between two screens. U.S. Pat. No. 6,109,538 by Villani et al.

The use of filtering devices is known in the prior art. However, the referenced prior art deals with a personal drinking water purification tube and an apparatus for filtration, respectfully. U.S. Pat No. 5,045,195 by Spangrud et al U.S. Pat. No. 4,564,452 by Sharpe.

The use of filtering devices is known in the prior art. However, the referenced prior art deals with a porous plastic dispensing article. U.S. Pat. No. 6,024,012 by Luzenberg, Jr.

The use of filtering devices is known in the prior art. However, the referenced prior art deals with a shroud for a bottle mounted filters. U.S. Pat. No. 6,153,096 by Nonren, Jr.

The use of filtering devices is known in the prior art. However, the referenced prior art deals with a personal portable liquid filter device. U.S. Pat. No. 6,142,384 by Shafik.

The use of filtering devices is known in the prior art. However, the referenced prior art deals with a demountable filter for a bottle or the like. U.S. Pat. No. 5,928,512 by Hatch et al.

The use of filtering devices is known in the prior art. However, the referenced prior art deals with a filtered drinking straw for reducing the amount of impurities in an aqueous solution and method for using the same. This filtering drinking straw is used for the filtration of bacterias and the like. U.S. Pat No. 5,156,335 by Smith et al.

The use of filtering devices is known in the prior art. However, the referenced prior art deals with a drinking water supply container having a removably mounted filter device. U.S. Pat No. 5,122,272 by lana et al.

While these devices satisfy their respective particular objectives, requirements and scope, the above mentioned patents do not disclose a filtered drinking straw similar to the inventive device and the objectives, advantages and scope disclosed in the subsequent sections. The inventive device includes a filtered drinking straw for filtering liquids passing through the drinking straw tube. The filtered drinking straw is an elongated upright tube possessing a pair of positioned aperture ends with a filtering apparatus that prevents objects of a predetermined size, the same size of or smaller than the diameter of the tube from entering the tube. This filtering apparatus is affixed either at one aperture end or runs the length of the tube allowing liquids to pass around the filtering apparatus but not the objects of a predetermined size from entering the tube.

The prior art listed may be perfectly suitable for the purposes, which they were designed, however, they would not be suitable for the purposes of the present invention, as hereinafter described.

Accordingly, the filtered drinking straw described, there are various objects and advantages of the present invention:

(a) to provide a drinking straw that will minimize citrus seeds from entering the tube;

(b) to provide a drinking straw that will minimize citrus seeds from being trapped in the tube;

(c) to provide a drinking straw that will minimize citrus seeds from being consumed by consumers;

(d) to provide a drinking straw that will minimize consumer embarrassment once the citrus seed is consumed—in other words, to reduce the improper way of disposing of the citrus seed, either by swallowing the citrus seed or spitting the citrus seed in a napkin and o hand;

(e) to provide a drinking straw that will increase the consumption of citrus flavored beverages by those consumers afraid to ingest such citrus seeds.

Further objects and advantages will become apparent from a consideration of the ensuing description and drawings.

### SUMMARY OF THE PRESENT INVENTION

In accordance with the present invention an elongated upright tube possessing a pair of opposite positioned aperture ends, containing a filtering apparatus affixed to the tube, which prevents objects of a predetermined size from entering the tube.

### BRIEF DESCRIPTION OF THE DRAWINGS

In order that the invention may be more fully understood, it will now be described, by way of example, with reference to the accompanying drawings in which:

FIG. 1 is an expanded sidelong view of a traditional non-filtered drinking straw with a citrus seed stuck within. This traditional drinking straw is known in the prior art.

FIG. 2 is an expanded sidelong view of the present invention, filtered drinking straw with the citrus seed blocked by the filtering apparatus affixed only to one end.

FIG. 3 is an expanded sidelong view of the bendable region, non-filtered drinking straw with a citrus seed stuck within. This bendable region, drinking straw is known in the prior art.

FIG. 4 is an expanded sidelong view of the present invention, filtered drinking straw that possesses a bendable neck with the citrus seed blocked by the filtering apparatus affixed only to one end.

FIG. 5 is an expanded sidelong view of the present invention showing the inventive filtered drinking straw with the citrus seed blocked by the filtering apparatus affixed to the entire length of the filtered drinking straw.

FIG. 6 shows the bottom view of FIG. 2.

FIG. 7 shows the bottom view of FIG. 4.

FIG. 8 shows the bottom view of FIG. 5.

FIG. 9 a sidelong view showing FIG. 1 in a container of citrus seeds and liquid.

FIG. 10 a sidelong view showing FIG. 2 in a container of citrus seeds and liquid.

FIG. 11 a sidelong view showing FIG. 4 in a container of citrus seeds and liquid.

FIG. 12 a sidelong view showing FIG. 5 in a container of citrus seeds and liquid.

### LIST OF REFERENCE NUMERALS

With regard to the reference numerals used, the following numbering is used throughout the various figures.

100 traditional non-filtered drinking straw

101 citrus seed stuck within the traditional non-filtered drinking straw

102 traditional straw aperture without filtering device

103 filtered drinking straw

104 citrus seed blocked by filtering apparatus

105 filtering apparatus affixed to one aperture

106 bendable region, non-filtered drinking straw

107 bendable region

108 bendable region, filtered drinking straw

109 filtered extended drinking straw which is affixed to the entire length of the straw

110 filtering apparatus affixed to the entire length of the straw

111 container

112 liquid

### DESCRIPTION OF THE PREFERRED EMBODIMENT(S)

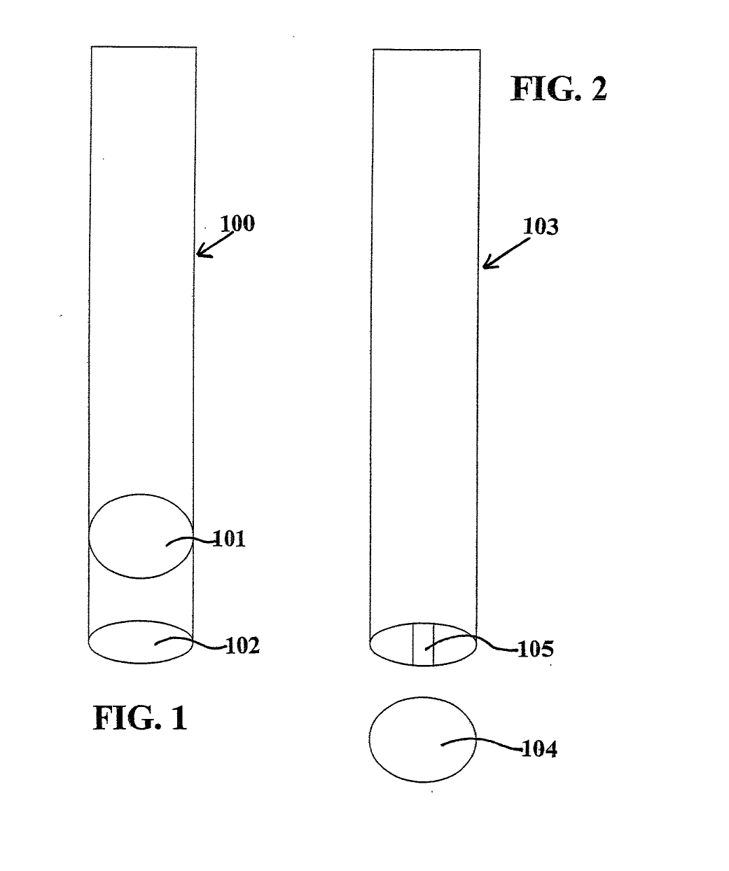

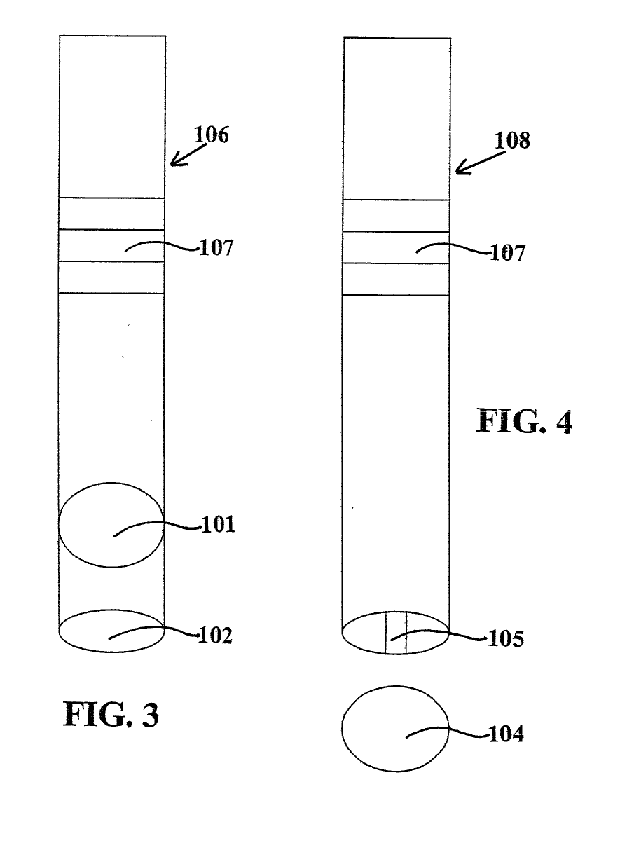

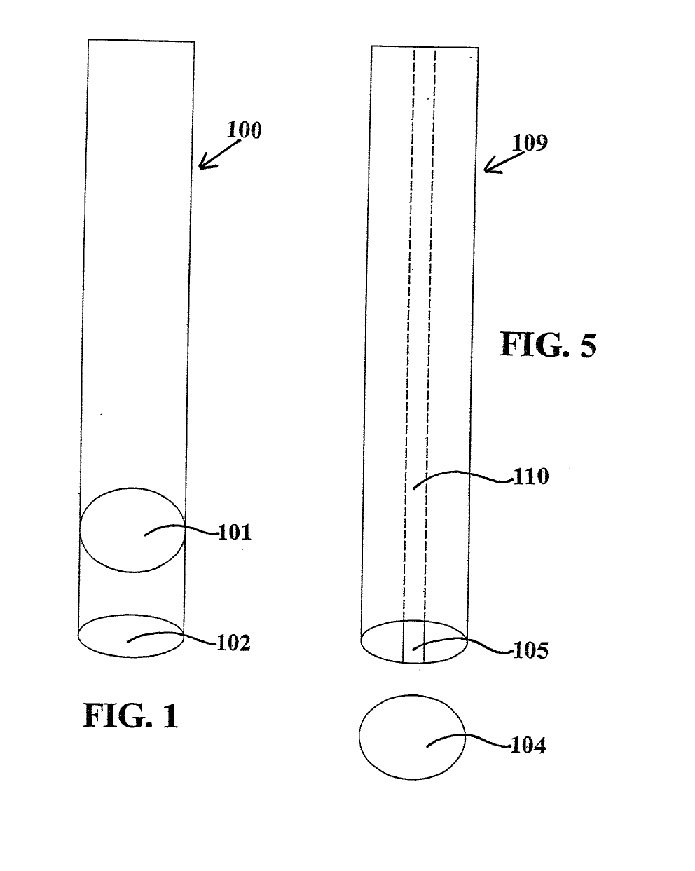

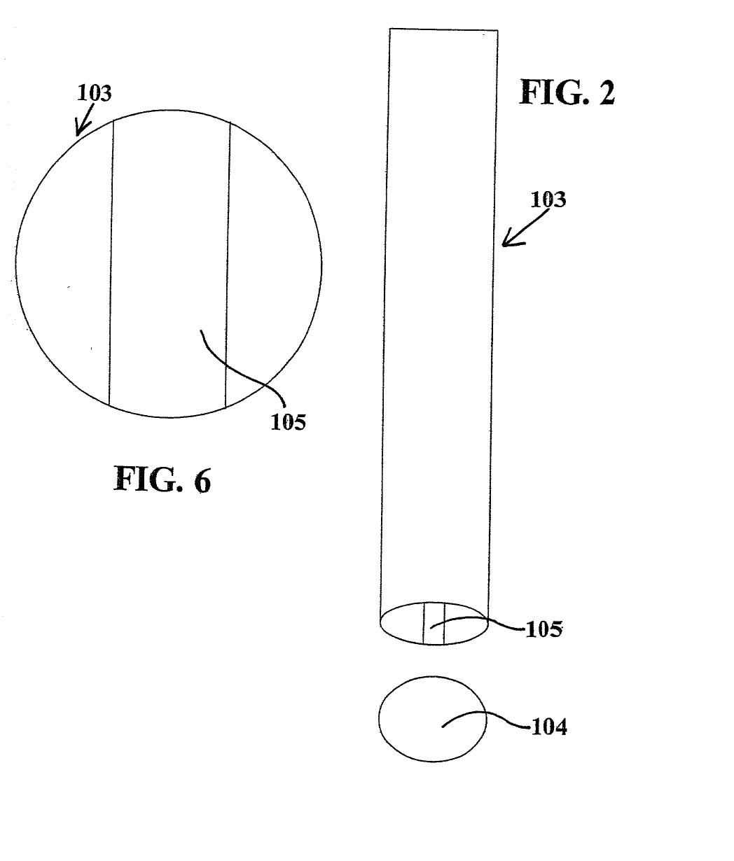

Turning now descriptively to the drawings, in which similar reference characters denote similar element throughout the several views, FIG. 1, 3, and 9 illustrates the non-filtered drinking straw. On the other hand FIG. 2,4, 5, 6, 7, 8, 10, 11, and 12 illustrates the present invention being a filtered drinking straw.

Turning to FIG. 1, therein is an embodiment showing an expanded sidelong view of a traditional non-filtered drinking straw 100. The traditional non-filtered drinking straw 100 has within it a stuck citrus seed 101. An open aperture 102 allows a citrus seed 101 entry into the non-filtered drinking straw 100.

Turning to FIG. 2, therein is an embodiment showing an expanded sidelong view of a filtered drinking straw 103. The present invention, the filtered drinking straw 103 has an affixed filtering apparatus 105 affixed to an aperture. A blocked citrus seed 104 cannot pass the filtering apparatus 105 of the filtered drinking straw 103.

Turning to FIG. 3, therein is an embodiment showing an expanded sidelong view of a bendable region, non-filtered drinking straw 106. The bendable region, non-filtered drinking straw 106 has within it the stuck citrus seed 101 below a bendable region 107. The open aperture 102 allows the citrus seed 101 enter into the bendable region, non-filtered drinking straw 106.

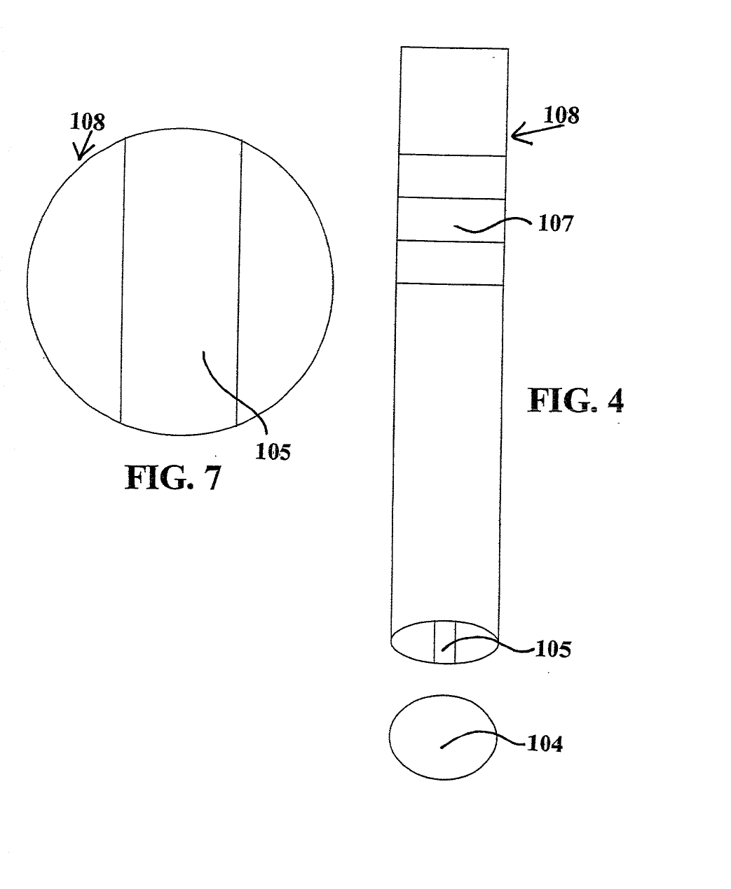

Turning to FIG. 4, therein is an additional embodiment showing an expanded sidelong view of a bendable region, filtered drinking straw 108. The bendable region, filtered drinking straw 108 has an affixed filtering apparatus 105 affixed to an aperture. The citrus seed 104 does not affect the bendable region 107. The blocked citrus seed 104 cannot pass the filtering apparatus 105 of the bendable region, filtered drinking straw 108.

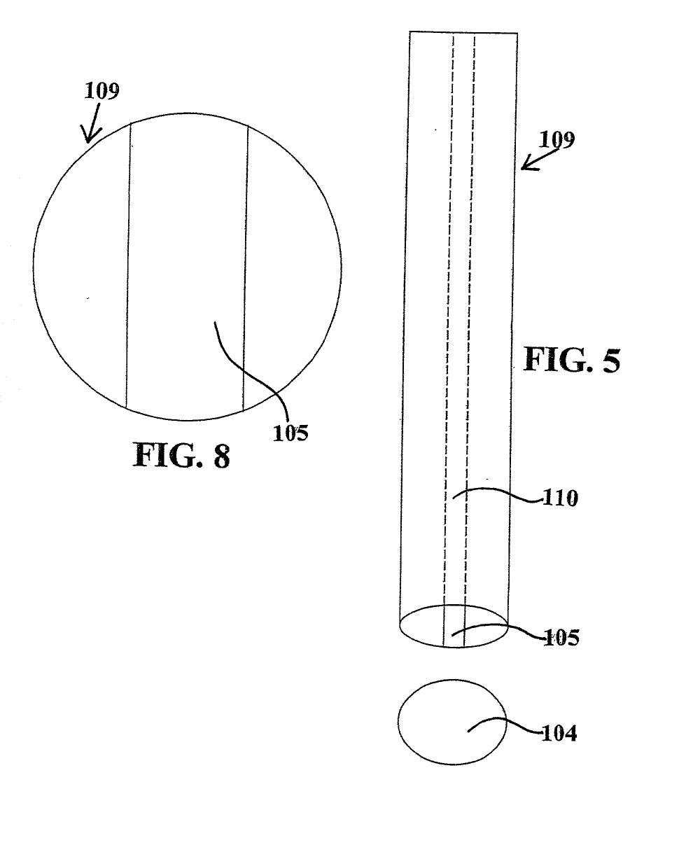

Turning to FIG. 5, therein is an additional embodiment showing an expanded sidelong view of a filtered extended drinking straw 109. The present invention, the filtered extended apparatus drinking straw 109 has an affixed filtering apparatus 105 affixed to a length 110 determined by the filtered extended apparatus drinking straw 109. The blocked citrus seed 104 cannot pass the filtering apparatus 105 of the filtered extended apparatus drinking straw 109.

Turning to FIG. 6, therein is an embodiment showing an expanded underside view of the filtered drinking straw 103. Also illustrated in FIG. 6, is the filtering apparatus 105,

Turning to FIG. 7, therein is an embodiment showing an expanded underside view of the bendable region, filtered drinking straw 108. Also illustrated in FIG. 7, is the filtering apparatus 105.

Turning to FIG. 8, therein is an embodiment showing an expanded underside view of the filtered extended apparatus drinking straw 109. Also illustrated in FIG. 8, is the filtering apparatus 105.

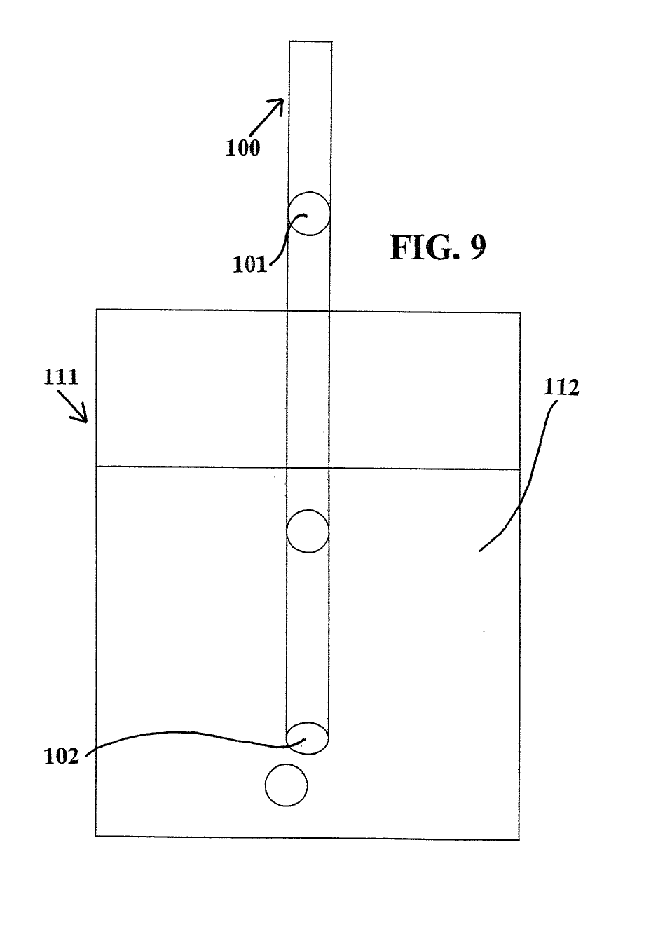

Turning to FIG. 9, therein is an embodiment showing a sidelong view of the traditional drinking straw 100 in a container 111 submerged in liquid 112. Because of the absence of the filtrating apparatus 105 the citrus seeds 101 are stuck in the traditional drinking straw 100.

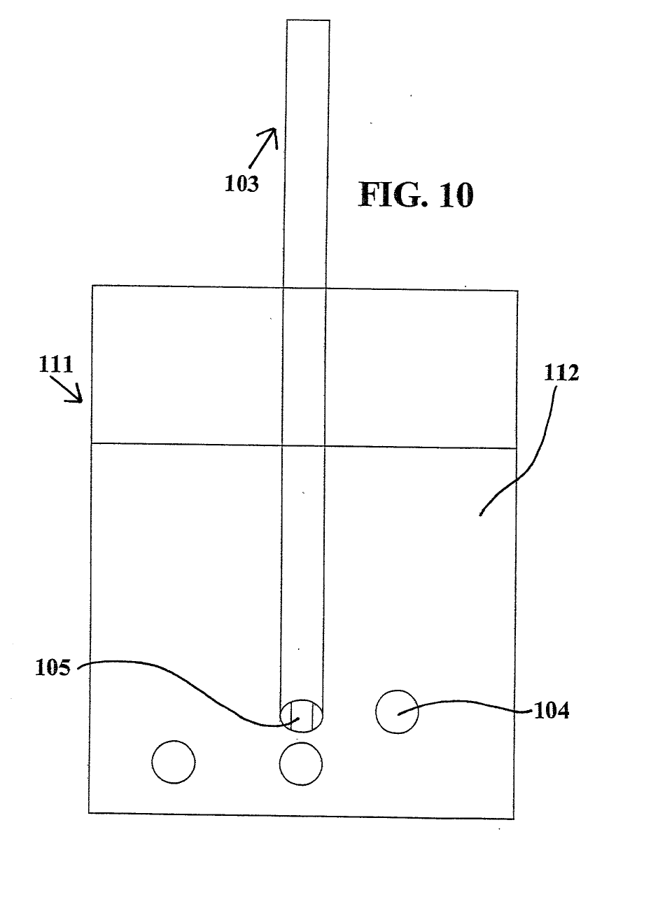

Turning to FIG. 10, therein is an embodiment showing a sidelong view of the filtered drinking straw 103 in the container 111 submerged in liquid 112. The filtering apparatus 105 blocks citrus seeds 104 from entering the filtered drinking straw 103.

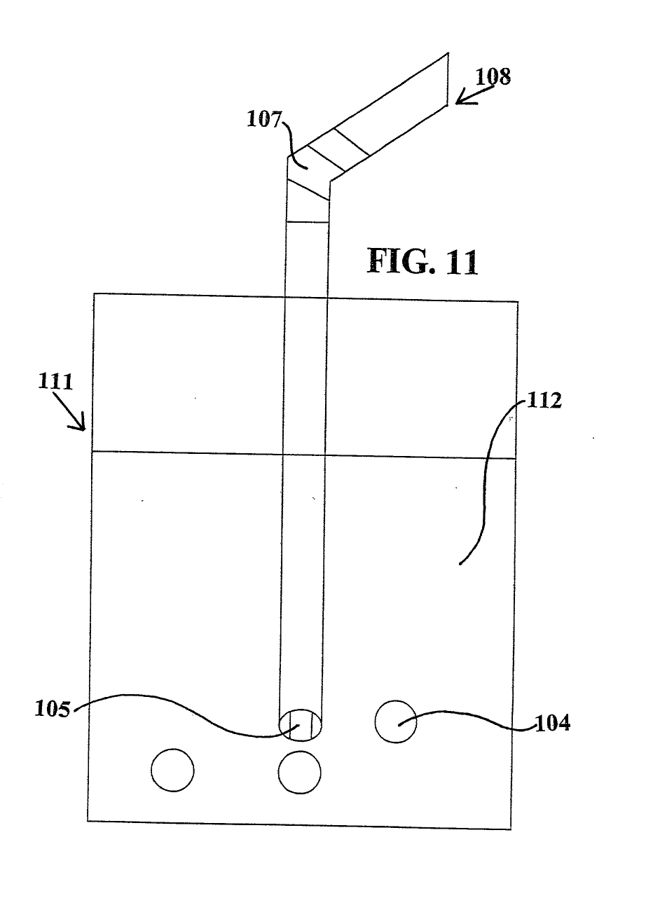

Turning to FIG. 11, therein is an additional embodiment showing a sidelong view of the bendable region, filtered drinking straw 108 in the container 111 submerged in liquid 112. The filtering apparatus 105 blocks citrus seeds 104 from entering the filtered drinking straw 103. Furthermore, the filtration apparatus 105 protects the bendable region 107 from harm.

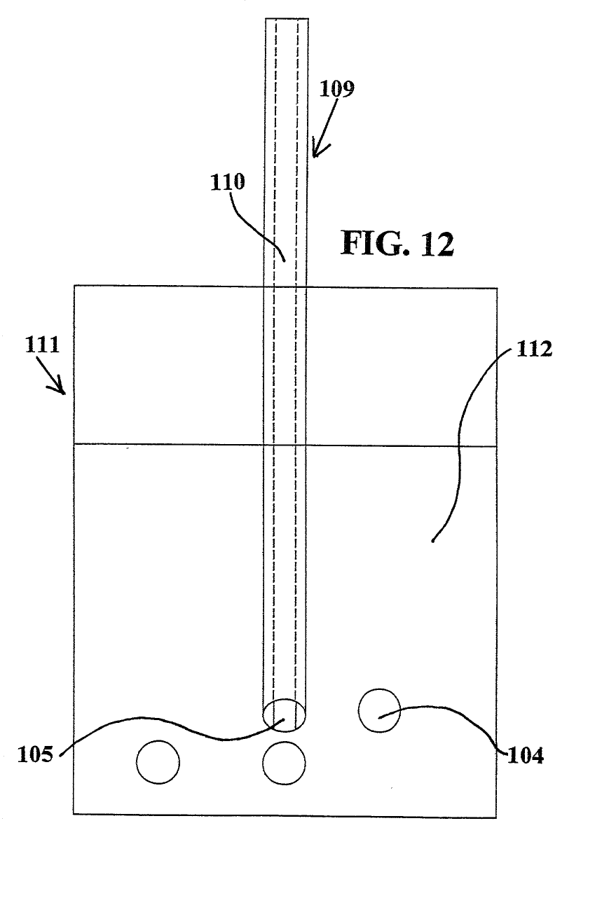

Turning to FIG. 12, therein is an additional embodiment showing a sidelong view of the filtered extended apparatus, drinking straw 109 in the container 111 submerged in liquid 112. The filtering apparatus 105 affixed to the entire length of the straw 110 blocks citrus seeds 104 from entering the filtered extended apparatus drinking straw 109.

Thus the reader will see that the filtered drinking straw provides an effective, simple, yet economical device that can be utilized by persons of every age.

While my above description contains many specificities, these should not be construed as limitations on the scope of the invention, but rather as an exemplification of one of the preferred embodiment thereof. Many other variations are possible. For example, the filtered drinking straw could be in a variety of shapes, designs, colors, sizes, and materials utilized. Furthermore, the filtering apparatus affixed to one aperture and or the filtering apparatus, which runs the length of the filtered drinking straw could also be in a variety of shapes, designs, colors, sizes and materials utilized. There are no specificities on the affixing method that affixes either the filtering apparatus affixed to one aperture or the filtering apparatus, which runs the length of the filtered drinking straw, however, quality and safe affixing methods are implemented by those skilled in such affixing methods. Affixing methods are not specified simply because the inventor is not skilled in such methodology, however, those experts skilled in such methodology, are open and encouraged to utilize a variety of affixing methods commonly used or when newer methods are developed in the future.

I claim:

1. A filtered drinking straw comprising:
(a) an elongated upright tube possessing a pair of opposite positioned aperture ends,
(b) a filtering apparatus affixed to one said aperture end in said tube,
(c) said filtering apparatus prevents objects of a predetermined size from entering said aperture of said tube,
whereby said filtering apparatus of said aperture end of said tube will protect a consumer of liquids containing possible undesirable objects, and
whereby said consumer of liquids will not draw into the mouth said undesirable objects, and
whereby said consumer of liquids will not be embarrassed having consumed said undesirable objects.

2. The filtered drinking straw of claim 1, wherein said tube is perpendicular to said aperture ends.

3. The filtered drinking straw of claim 1, wherein said filtering apparatus has a predetermined size that will minimize the consumption of said undesirable objects.

4. The filtered drinking straw of claim 1, wherein liquids could pass through said filtering apparatus without confluent of liquids and said undesirable objects.

5. A filtered drinking straw comprising:
(a) an extended upright tube possessing a pair of opposite positioned aperture ends,
(b) a filtering apparatus affixed to both said aperture ends in said tube,
(c) said filtering apparatus extending the length of the said filtered drinking straw,
(d) said filtering apparatus prevents objects of a predetermined size from entering said aperture of said tube,
whereby said filtering apparatus of said aperture end of said tube will protect a consumer of liquids containing possible undesirable objects, and
whereby said consumer of liquids will not draw into the mouth said undesirable objects, and
whereby said consumer of liquids will not be embarrassed having consumed said undesirable objects.

6. The filtered drinking straw of claim 5, wherein said tube is perpendicular to said aperture ends.

7. The filtered drinking straw of claim 5, wherein said filtering apparatus has a predetermined size that will minimize the consumption of said undesirable objects.

8. The filtered drinking straw of claim 5, wherein said filtering apparatus has a predetermined length throughout said tube that will minimize the consumption of said undesirable objects.

9. The filtered drinking straw of claim 5, wherein liquids could pass through said filtering apparatus without confluent of liquids and said undesirable objects.

10. A filtered drinking straw comprising:
(a) an extended upright tube possessing a pair of opposite positioned aperture ends,
(b) a filtering apparatus affixed to one said aperture end in said tube,
(c) a bendable region comprising a plurality of accordion-like pleats permitting bending of said tube,
(d) said filtering apparatus prevents objects of a predetermined size from entering said aperture of said tube,
whereby said filtering apparatus of said aperture end of said tube will protect a consumer of liquids containing possible undesirable objects, and
whereby said consumer of liquids will not draw into the mouth said undesirable objects, and
whereby said consumer of liquids will not be embarrassed having consumed said undesirable objects.

11. The filtered drinking straw of claim 10, wherein said tube is perpendicular to said aperture ends.

12. The filtered drinking straw of claim 10, wherein said filtering apparatus has a predetermined size that will minimize the consumption of said undesirable objects.

13. The filtered drinking straw of claim 10, wherein said tube has a bendable region comprising a plurality of accordion-like pleats permitting bending of said tube.

14. The filtered drinking straw of claim 10, wherein liquids could pass through said filtering apparatus without confluent of liquids and said undesirable objects.
